(19) United States
(12) Patent Application Publication
(10) Pub. No.: US 2008/0111366 A1
(43) Pub. Date: May 15, 2008

(54) Detachable notebook

(76) Inventor: Jian Tao, Shenzhen (CN)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/880,994

(22) Filed: Jul. 25, 2007

(30) Foreign Application Priority Data
Nov. 13, 2006 (CN) 200620157940.2

(51) Int. Cl. B42D 3/04; B42D 3/00

(52) U.S. Cl. 281/4; 281/29; 281/34

(57) ABSTRACT

A detachable notebook has a front cover, a rear cover and a notebook body. The notebook body has a front endpaper facing the front cover, a rear endpaper facing the rear cover and sheets sandwiched between the endpapers. The covers each comprise at least one magnetic strip disposed therein. The endpapers each comprises at least one magnetic strip disposed therein, and thus the covers and the notebook body are magnetically coupled together by way of the opposite magnetic strips. Alternatively, the front cover and the rear cover are formed as a unitary housing.

### BACKGROUND OF THE INVENTION

1. Field of Invention

The present invention relates generally to the field of stationery, and more specifically to a detachable notebook the covers of which are capable of being easily detached and replaced.

2. Description of Related Art

In recent years, hard-covered notebooks are becoming popular high-grade stationery. Normally, the consumers' attentions are drawn by the covers of the notebooks. In order for the consumers to reuse the notebook covers which are selected, it is desirable that additional writing sheets or notebooks can be provided independent of the covers. Traditionally, the front cover, rear cover and the writing sheets of a notebook are fixedly bound together.

### BRIEF SUMMARY OF THE INVENTION

The present invention provides a detachable notebook the covers of which are detachable and can be replaced according to the consumer's personal preference.

The detachable notebook comprises a front cover, a rear cover and a notebook body. The body comprises a front endpaper, a rear endpaper, and a plurality of sheets sandwiched therebetween. The front cover, rear cover, front endpaper and rear endpaper each comprise magnetic means made of magnetic materials. Thus, the front cover, rear cover and the notebook body are magnetically coupled together by the magnetic means to secure the notebook in the cover.

Alternatively, the front cover and the rear cover may be integrated to provide a housing to accommodate the notebook body. The housing is magnetically coupled with the notebook body by the magnetic means of the front cover, rear cover, front endpaper and rear endpaper.

The front cover, rear cover, front endpaper and rear endpaper may have a double-layer configuration to accommodate the magnetic means. The double-layer configuration comprises an upper layer and an opposite lower layer, to sandwich the magnetic means therebetween. Thus, the magnetic means are invisible.

With the double-layer configuration, the housing and body of the notebook are coupled together by the magnetic means hidden respectively within the front cover, rear cover, front endpaper and rear endpaper. Thus, the housing of the notebook can be conveniently detached and replaced, depending on the consumers' requirements and preferences.

### BRIEF DESCRIPTION OF THE DRAWINGS

These and other features, advantages and benefits of the present application will be made apparent with reference to the following detailed description and accompanying figures, wherein like reference numerals refer to like features across the several views, and wherein:

FIG. 1 illustrates an exploded perspective view of the notebook according to an exemplary embodiment of the present invention;

FIG. 2 illustrates an exploded perspective view of the notebook according to an alternative exemplary embodiment of the present invention; and

FIG. 3 illustrates an exploded perspective view of the double-layer configuration of the covers and endpapers.

### DETAILED DESCRIPTION OF THE INVENTION

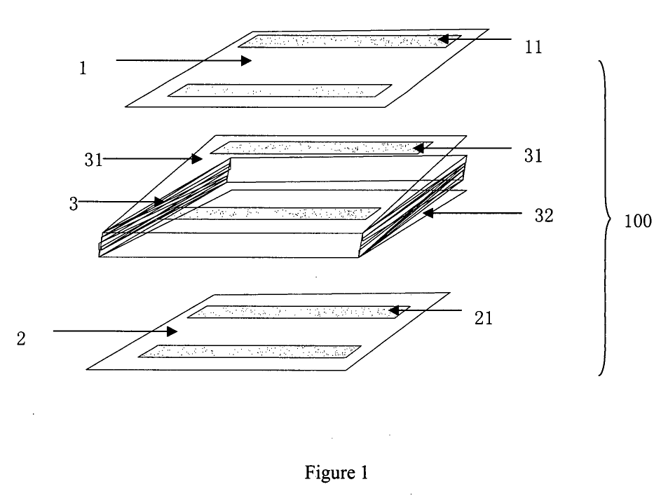

Referring now to FIG. 1, illustrated is a detachable notebook 100 according to one exemplary embodiment of the present invention. The notebook 100 comprises a front cover 1, a rear cover 2, and a notebook body 3. The notebook body 3 comprises a front endpaper 31 facing the front cover 1, a rear endpaper 32 facing the rear cover 2, and a plurality of sheets 6 bound between the endpapers. The front cover 1, rear cover 2, front endpaper 31 and rear endpaper 32 each comprise at least one magnetic means providing magnetic attractions. In this embodiment, the magnetic means contemplated by the present invention is a serial of magnetic strips. As illustrated in FIG. 1, at least one magnetic strip 11 is disposed within the front cover 1 of the notebook. Similarly, at least one magnetic strip 21 is disposed within the rear cover 2 of the notebook. As illustrated in FIG. 1, the front endpaper 31 and the rear endpaper 32 each comprise at least one magnetic strip 41 disposed within the respective endpaper at the locations substantially corresponding to the respective magnetic strips disposed within the covers. Thus, by means of the magnetic effects of the magnetic strips, the covers of the notebook are attracted to and coupled with the endpapers of the notebook when the covers are close to the endpapers.

In the exemplary embodiment, a pair of parallel magnetic strips are disposed to extend along the substantial length of the covers and the endpapers, as shown in FIG. 1.

However, it should be apparent to those skilled in the art that the magnetic means can be embodied by any other suitable shapes and profiles. For example, the magnetic means may be in the form of a short cylinder or torus. Further, the matching magnetic means of the front covers and the endpapers may be different, in terms of the shape and profile, to satisfy consumers' different requirements and preferences.

Further, the magnetic means may have different arrangements other than the parallel strip as long as the magnetic means of the covers and endpapers functioning to attract each other.

In addition, the magnetic means may be located and disposed at any suitable position of the covers and the endpapers. For example, the magnetic means may be disposed on the surfaces of the covers and the endpaper.

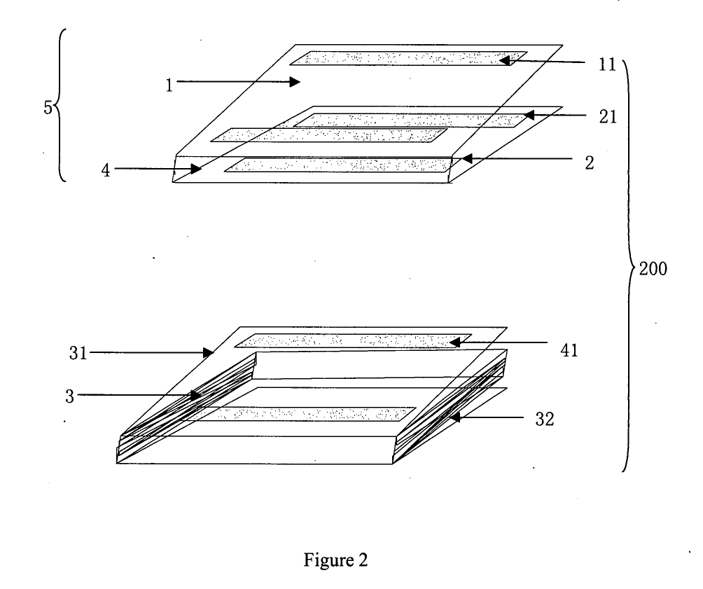

Referring now to FIG. 2, illustrated is a detachable notebook 200 according to an alternative embodiment of the present invention. The notebook 200 differs from the notebook 100 in that the front cover 1 and the rear cover 2 are integrated by a spine 4 to form a unitary housing 5. Similar to the first embodiment, at least one magnetic strip 11 is disposed within the front cover 1, and at least one magnetic strip 21 is disposed within the rear cover 2. The front endpaper 31 and the rear endpaper 32 of the notebook body 3 each have magnetic strips 41 disposed therein, to provide magnetic coupling of the housing 5 and the notebook body 3. However, it should be recognized that the front and rear covers may be integrated by any other suitable means, such as looped binders.

Preferably, the spine 4 and the notebook body 3 are configured to have a means for guiding the engagement between the spine 4 and the notebook body 3 and thereby providing a snug fit therebetween. For example, the spine 4 may have a curved cross section to form a concave receiving groove along the inner side of the spine. The notebook body 3 is formed to have a convex side opposite to the concave receiving groove and complementary to the concave receiving groove of the spine 4. Thus, when the notebook body 3 is attached to the housing 5, the matching profiles of the spine 4 and the notebook body 3 can provide guiding for the engagement between the concave receiving groove of the spine 4 and the convex side of the notebook body 3, and further a snug fit between the housing 5 and the notebook body 3. However, It should be apparent to those skilled in the art that the above engagement and snug fit can be realized by any other suitable structures, without departing from the scope or spirit of the present invention. For example, the notebook body may formed to have a concave receiving groove along the side, while the spine is curved inwardly to provide a convex matching surface.

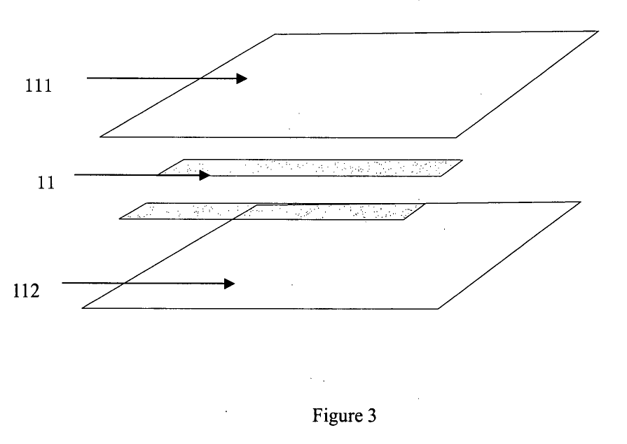

In order to enhance the aesthetic appearance of the notebook, the front cover 1, rear cover 2, front endpaper 31 and rear endpaper 32 may have double-layer configuration to hide the magnetic means. As illustrated in FIG. 3, the double-layer configuration of the front cover 1 comprises an upper layer 111 and an opposite lower layer 112. The magnetic strip 11 is fixedly sandwiched between the upper layer 111 and the lower layer 112. Thus, the magnetic strip 11 is hidden by the layers. The invisibility of the magnetic strips can greatly enhance the aesthetic appearance of the notebook. Further, this double-layered configuration of the covers and endpapers can prevent the magnetic means from losing or rusting.

Similarly, the rear cover 2, the front endpaper 31 and the rear endpaper 32 may have substantially the same double-layer configurations.

The present invention has been described with respect to certain exemplary embodiments. Certain alterations and/or modifications will be apparent to those skilled in the art, in light of the instant disclosure, without departing from the spirit or the scope of the invention. These embodiments are offered as merely illustrative, and not limiting, on the scope of the invention, which is defined solely with reference to the following appended claims.

1. A detachable notebook comprising:
a front cover;
a rear cover; and
a notebook body disposed between the front cover and the rear cover, comprising a front endpaper facing the front cover, a rear endpaper facing the rear cover, and a plurality of sheets sandwiched between the front endpaper and the rear endpaper,
wherein the front cover and the rear cover each comprise at least one magnetic means, and the front endpaper and the rear endpaper each comprise at least one magnetic means attractable respectively to the magnetic means of the front cover and the rear cover, thereby the front cover, rear cover and the notebook body being detachably and magnetically coupled together.

2. The detachable notebook according to claim 1, wherein the front cover and the rear cover are integrated to form a housing detachably and magnetically coupled with the notebook body.

3. The detachable notebook according to claim 1, wherein at least one of the front cover, the rear cover, the front endpaper and the rear endpaper comprise a double-layer configuration which comprises an upper layer and a lower layer to fixedly sandwich the magnetic means therebetween.

4. The detachable notebook according to claim 1, wherein the magnetic means comprises at least one magnetic strip.

5. The detachable notebook according to claim 4, wherein the magnetic strip is disposed to extend along the substantial length of the notebook.

6. The detachable notebook according to claim 5, wherein a pair of parallel magnetic strips are disposed along the substantial length of the notebook.

7. The detachable notebook according to claim 2, wherein the notebook further comprises a spine connecting the front cover and the rear cover to form the housing.

8. The detachable notebook according to claim 7, wherein the notebook comprises a means for guiding the engagement and providing a snug fit between the spine of the covers and the notebook body.

9. The detachable notebook according to claim 8, wherein the spine comprises a concave receiving groove along the substantial length of the notebook and the notebook body comprises a complementary convex side.

10. The detachable notebook according to claim 8, wherein the notebook body comprises a concave receiving groove along the substantial length of the notebook and the spine comprises a complementary convex inner side.
